(19) United States
(12) Patent Application Publication
(10) Pub. No.: US 2026/0154933 A1
(43) Pub. Date: Jun. 4, 2026

(54) ADAPTIVE CONFIDENCE THRESHOLDING WITH SALIENCY-DRIVEN REFINEMENT

(71) Applicant: QUALCOMM Incorporated, San Diego, CA (US)

(72) Inventors: Varun Ravi Kumar, San Diego, CA (US); Shubhankar Mangesh Borse, San Diego, CA (US); Senthil Kumar Yogamani, San Diego, CA (US)

(21) Appl. No.: 18/968,379

(22) Filed: Dec. 4, 2024

(51) Int. Cl. G06V 10/46; G06V 10/56; G06V 10/77; G06V 10/82; G06V 20/56

(52) U.S. Cl. CPC G06V 10/464; G06V 10/56; G06V 10/7715; G06V 10/82; G06V 20/56

(57) ABSTRACT

A method for saliency-driven refinement of object detection proposals includes obtaining image data generated by one or more sensors of a vehicle; extracting, from the image data, a plurality of features to generate a plurality of feature maps; upsampling the plurality of feature maps to generate a plurality of upsampled feature maps, wherein the upsampling increases a spatial resolution of the plurality of feature maps; projecting the plurality of upsampled feature maps onto a plurality of Bird's Eye View (BEV) feature maps; generating, based on the plurality of BEV feature maps, a plurality of object detection proposals for the image data; generating one or more saliency maps for the image data; and applying a confidence threshold, based on the one or more saliency maps, to the plurality of object detection proposals to generate refined object detection proposals.

### TECHNICAL FIELD

This disclosure relates to image processing.

### BACKGROUND

Among other challenges, autonomous driving systems need to accurately detect and track moving objects such as vehicles, pedestrians, and cyclists in real time. In autonomous driving, proposal generation is an important step in 3D Object Detection (3DOD) networks. Proposal generation involves the system generating a set of potential object detections, or proposals, within a given frame or scene. The generated proposals are then evaluated and refined to identify the actual objects present. In many contemporary autonomous driving systems, the 3DOD network generates a large number of proposals for each frame or scene. This approach ensures that a wide range of potential object locations and sizes are considered. In some examples, the 3DOD network may generate 200 proposals per frame.

### SUMMARY

This disclosure describes techniques for enhancing the semantic understanding of a scene in 3D object detection. These techniques may involve recovering fine-grain details that might have been lost due to downsampling feature maps during the detection process. By more accurately detecting scene semantics, the disclosed techniques may correct instances where valid object detections are inaccurately suppressed by a confidence threshold.

The disclosed techniques may employ upsampling of the low-resolution feature maps. Upsampling may increase the spatial resolution of the features, allowing for a finer-grained analysis of the scene.

In one example, a method for saliency-driven refinement of object detection proposals includes obtaining image data generated by one or more sensors of a vehicle; extracting, from the image data, a plurality of features to generate a plurality of feature maps; upsampling the plurality of feature maps to generate a plurality of upsampled feature maps, wherein the upsampling increases a spatial resolution of the plurality of feature maps; projecting the plurality of upsampled feature maps onto a plurality of Bird's Eye View (BEV) feature maps; generating, based on the plurality of BEV feature maps, a plurality of object detection proposals for the image data; generating one or more saliency maps for the image data; and applying a confidence threshold, based on the one or more saliency maps, to the plurality of object detection proposals to generate refined object detection proposals.

In another example, a system for saliency-driven refinement of object detection proposals includes: a memory for storing image data; and processing circuitry in communication with the memory, wherein the processing circuitry is configured to: obtain the image data generated by one or more sensors of a vehicle; extract, from the image data, a plurality of features to generate a plurality of feature maps; upsample the plurality of feature maps to generate a plurality of upsampled feature maps, wherein the upsampling increases a spatial resolution of the plurality of feature maps; project the plurality of upsampled feature maps onto a plurality of Bird's Eye View (BEV) feature maps; generate, based on the plurality of BEV feature maps, a plurality of object detection proposals for the image data; generate one or more saliency maps for the image data; and apply a confidence threshold, based on the one or more saliency maps, to the plurality of object detection proposals to generate refined object detection proposals.

In yet another example, non-transitory computer-readable storage media having instructions encoded thereon, the instructions configured to cause processing circuitry to: obtain image data generated by one or more sensors of a vehicle; extract, from the image data, a plurality of features to generate a plurality of feature maps; upsample the plurality of feature maps to generate a plurality of upsampled feature maps, wherein the upsampling increases a spatial resolution of the plurality of feature maps; project the plurality of upsampled feature maps onto a plurality of Bird's Eye View (BEV) feature maps; generate, based on the plurality of BEV feature maps, a plurality of object detection proposals for the image data; generate one or more saliency maps for the image data; and apply a confidence threshold, based on the one or more saliency maps, to the plurality of object detection proposals to generate refined object detection proposals.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a block diagram illustrating implementation of a machine learning system trained to perform self-assessment of False Negatives (FNs) with saliency map and adaptive confidence threshold, in accordance with the techniques of this disclosure.

FIGS. 4A and 4B are block diagrams illustrating implementation of a FeatUp framework applied to both camera backbone features and polar BEV features, in accordance with the techniques of this disclosure.

FIG. 5 is a flowchart illustrating an example method for saliency-driven refinement of predictions, in accordance with the techniques of this disclosure.

### DETAILED DESCRIPTION

As noted above, in autonomous driving, proposal generation is an important step in 3D Object Detection (3DOD) networks. Proposal generation involves the system generating a set of potential object detections, or proposals, within a given frame or scene. The generated proposals are then evaluated and refined to identify the actual objects present. Traditional proposal generation techniques include assignment of a confidence score that indicates the likelihood of a corresponding proposal being a true positive (i.e., correctly identifying an object). A higher confidence score suggests a greater probability that the proposal corresponds to a real object. After proposal generation, the 3DOD network typically employs a proposal refinement step. The proposal refinement step may involve removing redundant proposals that overlap significantly. The proposal refinement may also involve extracting features from the region of interest defined by each proposal. Furthermore, the proposal refinement may include classifying proposals as instances of a specific object category (e.g., car, pedestrian, bicycle). However, the proposal refinement step may inadvertently suppress some true positive proposals.

One current approach in 3D object detection in autonomous driving systems and/or advanced driving assistance systems (ADAS) involves applying a confidence threshold to refine proposals. Proposals with confidence scores below this threshold are discarded. However, the confidence threshold mechanism may inadvertently suppress some true positive proposals. The chosen confidence threshold may be too stringent, leading to the rejection of genuine object detections that have confidence scores slightly below the threshold. The scene itself may introduce noise or ambiguity, making it difficult for the 3DOD network to assign accurate confidence scores to certain proposals. The 3DOD network may have limitations in ability of the network to accurately estimate confidence scores, which may lead to errors in the thresholding process.

The confidence threshold may act as a filter to remove false positives, which are proposals that incorrectly identify an object where none exists. In the context of autonomous driving and computer vision, setting a high threshold may inadvertently discard true positives, leading to inaccurate object detection. Suppression of true positive proposals may lead to a decrease in recall, which is the ability of the system to correctly identify all relevant objects. When true positives are filtered out, the computer vision system may miss important objects within the scene. This may significantly reduce the overall accuracy of object detection. The suppression may prevent the computer vision system from building a complete picture of the scene, and may hinder ability of the system to comprehend the environment and elements of the environment. Furthermore, the scene understanding issues may ultimately result in a decline in the overall performance of the 3DOD system. The preferred scenario would be to have a confidence threshold that effectively filters out all false positives while retaining all true positives. However, achieving this kind of balance may often be challenging in practice due to the following issues. The confidence scores of the 3DOD network may not always accurately reflect the actual presence of an object. Noise, ambiguity, and network limitations may lead to uncertainty.

Adjusting the threshold may impact the balance between precision (correctly identifying true positives) and recall (detecting all relevant objects). Increasing the threshold may improve precision but may reduce recall, and vice versa.

Therefore, finding the effective confidence threshold may involve a careful consideration of the specific application and requirements. Some scenarios may prioritize high precision, while others may benefit from better recall.

Precision may measure the proportion of correct detections (true positives) out of all detections made. Recall measures the proportion of true positives detected out of all true positives that exist in the scene. A high precision means that most of the detections made are correct, but the high precision may come at the cost of missing some true positives (low recall). A high recall means that most of the true positives are detected, but the high recall may also include some false positives (low precision). In autonomous driving systems the objective may be to find a confidence threshold that balances precision and recall achieving the desired overall performance. In other words, finding a confidence threshold may involve trying different thresholds and evaluating the resulting precision and recall metrics.

The specific requirements of the application may influence the desired balance. For example, since autonomous driving systems typically prioritize safety such systems may focus on high recall to ensure no objects are missed, while other systems, for efficiency, may prioritize high precision to avoid unnecessary processing.

This disclosure describes techniques for enhancing the semantic understanding of a scene in 3D object detection. These techniques may involve recovering fine-grain details that might have been lost due to downsampling feature maps during the detection process. By more accurately detecting scene semantics, the disclosed techniques may correct instances where valid object detections are inaccurately suppressed by a confidence threshold.

The disclosed techniques may employ upsampling of the low-resolution feature maps. Upsampling may increase the spatial resolution of the features, allowing for a finer-grained analysis of the scene

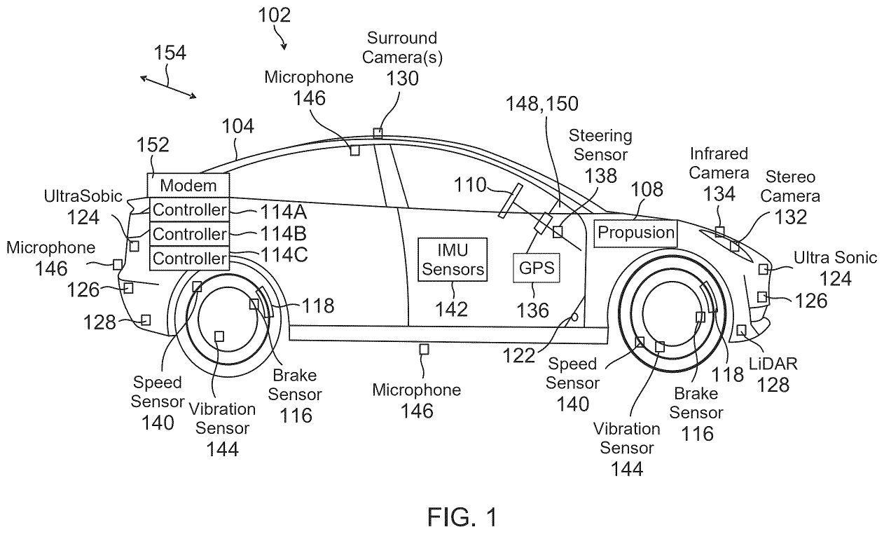

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the periphery of the vehicle 102. Camera type and lens selection depends on the nature and type of function. The vehicle 102 may have a mix of camera types and lenses to provide complete coverage around the vehicle 102. All camera locations on the vehicle 102 may support interfaces such as Gigabit Multimedia Serial link (GMSL) and Gigabit Ethernet.

In an aspect, a controller 114 may be configured to obtain image data generated by one or more sensors 126-134 of the vehicle 102. For example, sensors may include a combination of cameras 130-134. Next, controller 114 may extract, from the image data 215, a plurality of features to generate a plurality of feature maps. Controller 114 may then upsample the plurality of feature maps to generate a plurality of upsampled feature maps. The upsampling may increase a spatial resolution of the plurality of feature maps. Next, controller 114 may project the plurality of upsampled feature maps onto a plurality of BEV feature maps.

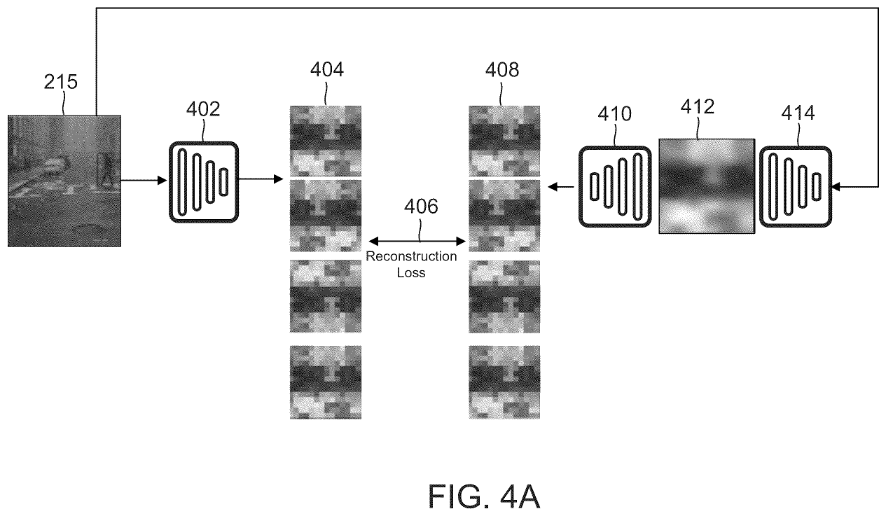

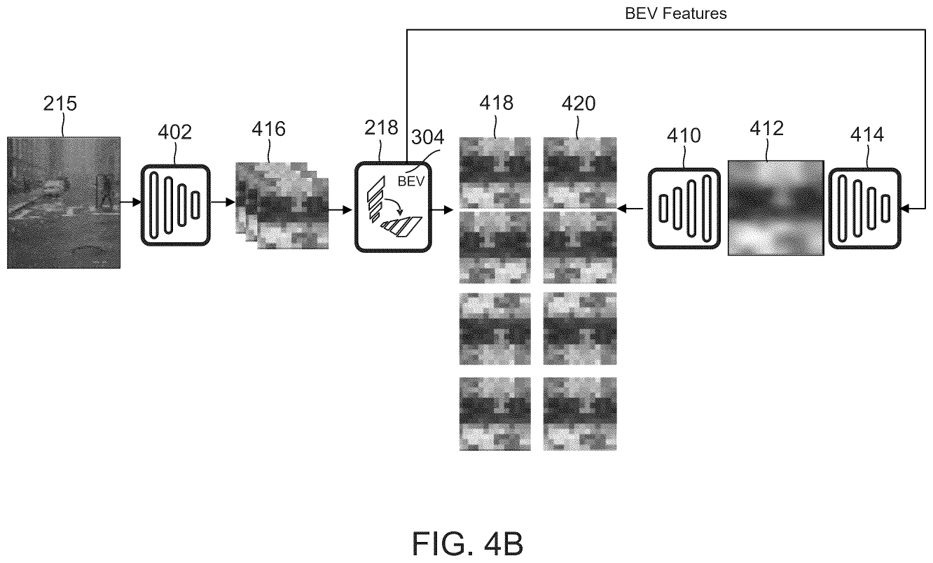

In accordance with the techniques of the present disclosure, the FeatUp framework (illustrated in FIGS. 4A and 4B) may be applied to both the camera backbone features and the polar BEV features to upsample the corresponding features. This double application may better ensure that the resulting feature maps (including the BEV feature maps) have rich spatial resolution, capturing both high-level semantic information and fine-grained details.

In an aspect, controller 114 may also generate, based on the plurality of BEV feature maps, a plurality of object detection proposals for the image data. Next, controller 114 may generate one or more saliency maps for the image data.

As will be explained below in more detail, saliency maps may guide the controller 114 to the relevant regions of the scene. Finally, controller 114 may apply a confidence threshold, based on the one or more saliency maps, to the plurality of object detection proposals to generate refined object detection proposals. Sometimes, accurate detections may be suppressed due to a strict confidence threshold. The semantic information obtained from saliency maps and FeatUp may provide valuable insights into the scene. By leveraging this semantic information, controller 114 may re-examine proposals that were initially discarded. If appropriate, controller 114 may adjust the confidence scores of proposals based on their semantic relevance.

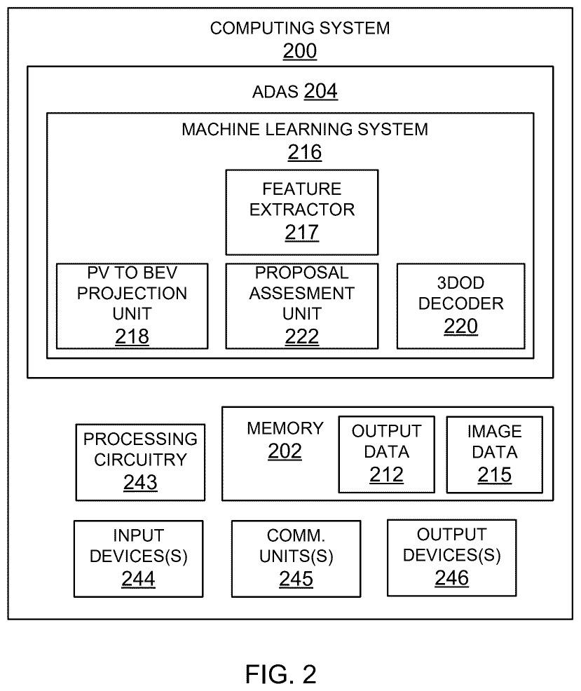

FIG. 2 is a block diagram illustrating an example computing system 200. As shown, computing system 200 comprises processing circuitry 243 and memory 202 for executing Machine Learning (ML) system 216 of ADAS 203, including feature extractor 217, PV (Perspective View) to BEV (Birds Eye View) projection unit 218, 3DOD decoder 220, and proposal assessment unit 222 which may represent an example instance of any controller 114 described in this disclosure, such as controller 114 of FIG. 1. ADAS 203 may comprise an autonomous driving system. ML system 216 may comprise various types of neural networks, such as, but not limited to, recursive neural networks (RNNs), convolutional neural networks (CNNs), and deep neural networks (DNNs). For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., feature extractor 217, PV to BEV projection unit 218, 3DOD decoder 220, and proposal assessment unit 222), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 203 using virtualization modules, such as a virtual machine or container executing on underlying hardware. One or more of such modules may execute as one or more services of an operating system or computing platform. Aspects of ADAS 203 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

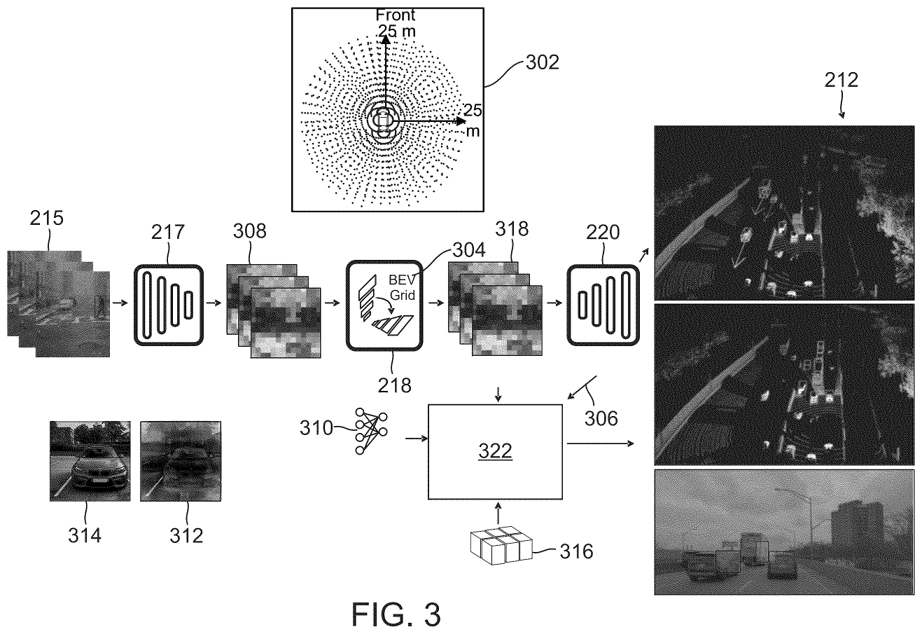

In the example of FIG. 2, feature extractor 217 may be configured to extract features from image data 215, as described herein. Feature extractor 217 may receive input from sensors such as, but not limited to, cameras 130-134. 3DOD decoder 220 may generate output data 212. Output data generated by feature extractor 217 (e.g., FeatUp feature maps) may be used as input data for PV to BEV projection unit 218 of the ML system 216 (as shown in FIG. 3). Image data 215 and output data 212 may contain various types of information. For example, image data 215 may include, but is not limited to, camera image data, LiDAR point cloud data, and so on. Output data 212 may include bounding box predictions, confidence scores, with False Negatives (FN) classified and corrected, and so on.

In an aspect, feature extractor 217 may comprise a CNN. In an aspect, the feature extractor 217 may receive a plurality of camera images. The feature extraction process may result in a plurality of feature maps. In an aspect, to improve the semantic understanding of the scene, the ML system 216 may recover the fine-grain details lost during feature map downsampling. In an aspect, FeatUp technique may be used to upsample low-resolution feature maps. The PV to BEV projection unit 218 may be configured to transform images captured from a perspective view (PV) into a bird's-eye view (BEV). The PV to BEV projection unit 218 may generate a plurality of BEV feature maps. In an aspect, the BEV feature maps may be divided into separate channels for positional coordinates and color values. An example 3DOD decoder 220 may predict 3D bounding boxes, classes of objects, and confidence scores within an image or point cloud, providing a semantic understanding of the environment. The proposal assessment unit 222 may be configured to adjust predictions of the 3DOD decoder 220 based on the information from the saliency maps, potentially restoring suppressed true positives or refining object boundaries.

In an aspect, well-calibrated confidence scores may be beneficial for effective thresholding. Calibration may better ensure that the confidence scores accurately reflect the probability of a detection being correct. Example techniques like Platt scaling or temperature scaling may adjust the confidence scores. Alternatively, instead of using a fixed confidence threshold, ML system 216 may implement a dynamic threshold that may be adjusted based on the distribution of confidence scores within a given scene. Advantageously, scene-specific adjustments may allow the confidence threshold to be more responsive to variations in scene complexity, noise levels, and object densities. By dynamically adjusting the confidence threshold, the ML system 216 may better balance precision and recall, potentially reducing the suppression of true positives.

A lower initial confidence threshold may be used during a Non-Maximum Suppression (NMS) to retain more proposals, including some proposals that may have been suppressed by a fixed confidence threshold. After the initial NMS, a secondary filtering step may be applied by ML system 216 to further refine the detections and remove any remaining false positives. The ML system 216 may be configured to balance precision and recall, which may help improve recall without significantly sacrificing precision. The suppression of true positives due to some example 3DOD techniques may be a significant problem that may hinder the effectiveness of 3D object detection performed by 3DOD decoder 220. By implementing dynamic confidence thresholding and post-processing techniques of this disclosure, the ML system 216 may mitigate this issue and improve the overall performance of the 3DOD decoder 220.

In an aspect, dynamic thresholding and post-processing may lead to more accurate object detection by reducing the suppression of true positives. These techniques may help increase recall, ensuring that more objects are detected.

The suppression of true positives is one issue in 3D object detection. As noted above, to address the suppression of true positives, the ML system 216 may be configured to find a balance between filtering out false positives (incorrect detections) and retaining true positives (correct detections). As discussed earlier, a dynamic confidence threshold that adjusts based on scene conditions may help improve recall without sacrificing precision. Techniques like, but not limited to, adaptive boosting or online learning may be used to dynamically adjust the threshold based on feedback from the performance of the ML system 216. In an aspect, incorporating saliency maps may provide additional information about the importance of different regions in the scene, potentially helping the proposal assessment unit 222 of the ML system 216 to refine confidence scores and reduce the suppression of true positives. Using contextual information, such as, but not limited to, object relationships or scene semantics, may also improve the accuracy of confidence scores.

To improve the semantic understanding of the scene, the ML system 216 may recover the fine-grain details lost during feature map downsampling. Generally, in the context of autonomous vehicles, recovering fine-grain details may include using techniques like deconvolution or transposed convolutions to upsample the feature maps and recover spatial details. ML system 216 may also employ attention mechanisms to focus on specific regions of the feature maps that are relevant for semantic understanding. Advantageously, by combining saliency maps and improved semantic understanding, FN assessment unit 22 may identify and correct predictions that are being unjustly suppressed by the confidence threshold. Such predictions may be corrected by re-evaluating proposals that were initially suppressed based on their saliency and semantic relevance.

Saliency maps (shown in FIG. 3) may highlight the regions of interest within an input image or scene. In the context of 3D object detection, saliency maps may identify areas that are more likely to contain objects or relevant information. In an aspect, FeatUp technique may be used to upsample low-resolution feature maps generated by the feature extractor 217.

By increasing the spatial resolution, FeatUp may help to capture and analyze the semantic details of the scene. It should be noted that FeatUp may be particularly useful when fine-grained details might have been lost due to downsampling.

In an aspect, downsampling may lead to a loss of spatial information, making it difficult for the ML system 216 to detect smaller or less prominent objects.

As explained earlier, saliency maps may guide the ML system 216 to the relevant regions of the scene. FeatUp techniques may help to recover fine-grained details that might have been missed due to downsampling. In other words, the disclosed combined techniques may help identify objects that might have been overlooked due to the size, appearance, or location of the objects.

Sometimes, accurate detections may be suppressed due to a strict confidence threshold. The semantic information obtained from saliency maps and FeatUp may provide valuable insights into the scene. By leveraging this semantic information, the proposal assessment unit 222 may re-examine proposals that were initially discarded. If appropriate, the proposal assessment unit 222 may adjust the confidence scores of proposals based on their semantic relevance. For example, this adjustment may help the proposal assessment unit 222 to restore true positive detections that were inaccurately suppressed.

In an example, ML system 216 may restrict the saliency-based corrections to a 50-meter range around the ego car (e.g., vehicle 102). This restriction may focus computational efforts on a more important detection area, where objects are most likely to pose immediate risks.

By limiting the scope, ML system 216 may reduce the computational overhead associated with saliency map generation and analysis, making the disclosed ML system 216 more efficient. The Polar Bird's Eye View (BEV) space (shown in FIG. 3) represents the scene using polar coordinates, with the vehicle 102 at the origin. The BEV representation may be more intuitive for representing objects in a 3D environment, especially for tasks like object detection and tracking. Polar coordinates align more naturally with the way humans perceive and reason about objects in space. Certain operations, like obstacle avoidance and path planning, may be more efficient in polar coordinates.

In some cases, the polar BEV space may reduce distortions that may occur in Cartesian coordinates, especially near the origin. Advantageously, by combining saliency-based corrections with the efficiency of limiting the range and the advantages of polar BEV space, the accuracy and robustness of 3D object detection may be improved.

As noted above, limiting the saliency-based corrections to a 50-meter range around the vehicle 102 may better ensure that the ML system 216 focuses on a more important detection area, improving the precision of object detection. Accurate detection of objects around the vehicle 102 may be beneficial for safe navigation and avoiding potential collisions. Integrating saliency maps into the 3DOD decoder 220 may help to enhance the accuracy and reliability of detections.

By leveraging saliency information, the proposal assessment unit 222 may reduce the loss of true positive detections, ensuring that more important objects are correctly identified.

Camera-based BEV methods typically transform 2D images from cameras into a top-down view, providing a more intuitive representation for 3D object detection. Various backbone architectures, including, but not limited to, ConvNeXt, ResNet, Swin, VIT, CLIP, and DINO, may be used to extract features from the BEV representation.

In the example of the framework illustrated in FIG. 3, positional and color embeddings may be incorporated to further enhance the feature maps. Processing text queries with the CLIP (Contrastive Language-Image Pre-training) model may provide additional semantic information about the scene, potentially improving object detection.

Fourier features are a mathematical tool that may be used by ML system 216 to decompose a signal (in this case, BEV feature maps) into constituent frequencies of the signal. In an aspect, by analyzing the Fourier transform of a signal, the ML system 216 may gain insights into frequency content of the BEV feature maps, which can be valuable for various tasks, including feature extraction and analysis. In simpler terms, the input signal (z) may be the BEV feature maps. The Discrete Fourier Transform (DFT) is a mathematical operation that transforms a signal from the time domain (or spatial domain in the case of images) to the frequency domain.

As noted above, the DFT may produce a set of frequency components (ω), each component representing a different frequency present in the input signal. The DFT coefficients are complex numbers, representing both the magnitude and phase of each frequency component. It should be noted that the discrete Fourier transform h(z,\hat{ω}) may be defined using the following formula (1):

$$h ( z , \hat{ω} ) = ℱ ( z ) = {Σ}_{n = 0}^{N - 1} z [ n ] {e}^{- i 2 π n \hat{ω} / N} \qquad ( 1 )$$

where:
h(z,\hat{ω}) is the Fourier transform of the signal z at frequency ω;
z[n] are the samples of the input signal z;
N is the total number of samples in the signal;
i is the imaginary unit (\sqrt{−1});
ω is the frequency index.
   The magnitude of a Fourier coefficient represents the amplitude of the corresponding frequency component in the input signal. The phase of a Fourier coefficient represents the phase shift of the corresponding frequency component.

In the context of 2D BEV input, @ may be a 2D vector representing the spatial frequency components in the x and y directions. The ML system 216 may apply the Fourier transform ( [symbol] ) to the BEV feature maps to analyze their frequency content. For 2D BEV input, the ML system 216 may compute Fourier features for both the positional coordinates and the color values. This computation may involve applying the DFT to the corresponding channels of the BEV feature maps. In this case, the BEV feature maps may be divided into separate channels for positional coordinates and color values.

In an aspect, the ML system 216 may apply the DFT to each channel separately. In an aspect, the result of the DFT may be a set of Fourier coefficients for each channel, representing the frequency content of that channel.

The Fourier features of the positional coordinates may reveal information about the spatial frequency content of the BEV feature map.

For example, high-frequency components may indicate sharp edges or rapid changes in the scene. Similarly, the Fourier features of the color values may reveal information about the frequency content of the color information. Advantageously, high-frequency components may indicate fine-grained color variations or textures.

Let eᵢ and eⱼ represent the 2D pixel coordinate fields ranging in [−1,1].

Accordingly, if eᵢ and eⱼ are already included as channels in the BEV feature maps, the ML system 216 may directly apply the Fourier transform to these channels. In an aspect, the ML system 216 may extract the channels corresponding to eᵢ and eⱼ from the BEV feature maps. The ML system 216 may apply the 2D DFT to the channels using formula (1). In one example, h(eᵢ:eⱼ,\hat{ω}) may represent the Fourier features of the positional coordinates, while h(colorvalues,\hat{ω}) may represent the Fourier features of the color values.

In summary, the ML system 216 may extract the Fourier features for both positional coordinates and color values, as described above.

Next, the ML system 216 may combine the Fourier features along the channel dimension. In other words, in an aspect, the ML system 216 may stack the features from both channels into a single tensor. The resulting concatenated features may represent a richer representation of the BEV feature maps, incorporating information from both positional and color components. In an aspect, the ML system 216 may employ a multi-layer perceptron (MLP) architecture with appropriate layers and activation functions. With the disclosed techniques, the ML system 216 may feed the concatenated Fourier features as input to the MLP. The MLP may process the input features and may generate a high-resolution BEV feature map. The output of the MLP may be a tensor representing the high-resolution BEV feature map. In an aspect, the ML system 216 may concatenate the Fourier features along the channel dimension, using the following formula (2):

$$features = concat ( Fourier Positional , Fourier Color ) \qquad ( 2 )$$

The process of passing the concatenated features through the MLP to obtain the high-resolution BEV feature map may be represented by the following formula (3):

$${BEVF}_{hr} = MLP ( h ( ei : ej : x , \hat{ω} ) ) \qquad ( 3 )$$

where x represents the input signal, and BEVFₕᵣ is the high-resolution BEV feature map. Concatenating Fourier features from both positional and color components may provide a more comprehensive representation of the BEV feature maps. In an aspect, the MLP may generate a high-resolution BEV feature map, which may be beneficial for tasks like object detection and segmentation that may operate better using fine-grained spatial information.

In an aspect, the ML system 216 may employ a CLIP model, which is a ML model that can understand both text and images. In an aspect, the CLIP model may be used to determine the relevance between text queries and visual features.

Text queries may be textual descriptions or questions related to the scene. In an aspect, examples of text queries may include, but are not limited to: “A car in the scene,” “A pedestrian crossing the street,” or “A traffic light.”

The ML system 216 may pass the high-resolution BEV feature map obtained from the previous steps as input to the CLIP model. Substantially simultaneously, the ML system 216 may input the text queries to the CLIP model. The CLIP model may process both the feature maps and the text queries and may compute relevance scores between them.

Higher relevance scores may indicate a stronger semantic relationship between the text query and the corresponding region of the feature map. The term Q may represent the set of text queries. The term BEVFₕᵣ may represent the high-resolution BEV feature map. In turn, the CLIP model may be applied to the feature map and text queries, resulting in relevance scores. The CLIP model may help the 3DOD decoder 220 understand the semantic content of the scene, improving the accuracy of object detection and segmentation. Text queries may provide valuable guidance to the 3DOD decoder 220, helping the decoder focus on specific objects or regions of interest.

In an aspect, clip_processor may represent a pre-trained CLIP model processor that handles the preprocessing of text and image inputs for the CLIP model.

In an aspect, text=Q may represent the set of text queries, which are the textual descriptions or questions related to the scene; images=BEVFₕᵣ may be the high-resolution BEV feature map obtained from the previous steps. This can be represented by formulas (4) and (5):

$$inputs = ( clip\_processor text = Q , images = {BEVF}_{hr} ) \qquad ( 4 )$$

$$outputs = clip\_model ( inputs ) \qquad ( 5 )$$

Here, the line clip_model (inputs) may call the CLIP model and may pass the preprocessed text and image inputs as arguments. The CLIP model may process these inputs and may compute the relevance scores between the text queries and the image features.

The variable outputs may store the output of the CLIP model. The specific structure of outputs may vary depending on the CLIP model implementation, but the outputs variable may contain the computed relevance scores and other relevant information. The disclosed techniques may extract the target score corresponding to the desired text query, using the following formula (6):

$$target\_score = outputs . logits\_per \_image [ : , target\_query \_index ] \qquad ( 6 )$$

As a non-limiting example scenario, outputs.logits_per_image may refer to a tensor containing the logits (pre-softmax scores) for each image and each text query. The term [:,target_query_index] may select the column corresponding to the target text query index, effectively extracting the relevance scores for that query for all images.

Next, the ML system 216 may initiate the backpropagation process. The ML system 216 may calculate the gradients of the target score with respect to the high-resolution feature map BEV Fₕᵣ. The ML system 216 may extract the computed gradients, which represent how changes in the high-resolution feature map would affect the target score, using the following formula (7):

$$gradients = \frac{target\_score}{\partial {BEVF}_{hr}} \qquad ( 7 )$$

The ML system 216 may store the original high-resolution feature map BEV Far for future use.

The CLIP model may compute the target score based on the high-resolution feature map and the text query. The ML system 216 may trigger backpropagation, which may calculate how changes in the feature map would affect the target score. The computed gradients may be stored in the gradients variable. The original high-resolution feature map may be stored in the feature_maps variable, for example.

FIG. 3 is a block diagram illustrating implementation of a machine learning system trained to perform self-assessment of False Negatives (FNs) with a saliency map and adaptive confidence threshold, in accordance with the techniques of this disclosure. As shown in FIG. 3, the ML system 216 may use polar coordinates (radius, angle) to represent points in the BEV plane 302. Polar coordinates may be beneficial for capturing rotational invariance and handling objects with circular or elliptical shapes. The BEV plane 302 may be divided into a grid of cells (e.g., BEV grid 304), and BEV features may be extracted for each cell. The BEV grid 304 may provide a structured representation of the scene, making it easier to process and analyze the BEV features.

The 3DOD decoder 220 may generate a large number of box proposals 306 (e.g., 300 proposals). By applying a confidence threshold, the proposal assessment unit 222 may filter out low-confidence predictions, reducing the number of false positives and improving the overall accuracy. However, setting the confidence threshold too high may lead to the suppression of true positive predictions, especially for objects with lower confidence scores.

The 3DOD decoder 220 may output the box proposals 306, which may include, but are not limited to 3D bounding box predictions, class probabilities, and confidence scores. The BEV grid 304 may be used by the ML system 216 to represent the scene in a top-down view, providing a structured representation that may be easily integrated with the predictions of the 3DOD decoder 220.

As shown in FIG. 3, the ML system 216 may take as input image data 215 which may comprise a sequence of images. The feature extractor 217 (e.g., a convolutional neural network) may extract features from the image data 215. In an aspect, the extracted features may be upsampled to a higher resolution FeatUp features 308 to match the BEV grid 304 (as shown in FIGS. 4A and 4B).

The PV to BEV projection unit 218 may project PV images onto the BEV plane 302 using techniques like, but not limited to, inverse perspective mapping. The ML system 216 may use the CLIP model 310 to extract features from the images and text queries, enabling multimodal understanding of the scene.

The proposal assessment unit 222 may evaluate predictions generated by the 3DOD decoder 220 to identify potential false negatives. False negatives may occur when the 3DOD decoder 220 fails to detect an object that is actually present.

Saliency map 312 may be used to identify regions of the image (e.g., image 314) that are more important for object detection. The saliency map may help the proposal assessment unit 222 to focus attention on relevant areas of the image 314. By dynamically adjusting the confidence threshold based on the saliency of the region, the proposal assessment unit 222 may better balance precision and recall.

Visualizing the saliency map 312 may provide insights into the regions that the proposal assessment unit 222 determines to be more important for object detection. In an aspect, visualizing the weight and bias kernels of the 3DOD decoder 220 may help to understand how the 3DOD decoder 220 is making predictions.

Position and color encoding techniques described above may be used by the ML system 216 to encode spatial and color information 316 into the BEV grid features 318, improving the ability of the proposal assessment unit 222 to detect and classify objects.

In summary, the ML system 216 may extract high-frequency information from the BEV feature maps, capturing fine-grained details and spatial variations. The ML system 216 may compute Fourier features for both positional coordinates and color values, providing a comprehensive representation of the scene.

Next, the ML system 216 may combine Fourier features from positional and color information 316. The ML system 216 may pass the concatenated features through a multi-layer perceptron (MLP) to generate a high-resolution BEV feature map.

In an aspect, the ML system 216 may employ the CLIP model 310 to process text queries and compute their relevance to the high-resolution BEV feature map. The ML system 216 may generate saliency maps 312 based on the relevance scores, highlighting more important regions of the scene. The proposal assessment unit 222 may compare the saliency maps 312 with the predictions of the 3DOD decoder 220 to identify potential discrepancies or missed detections. The proposal assessment unit 222 may adjust 3DOD predictions based on the information from the saliency maps 312, potentially restoring suppressed true positives or refining object boundaries. The integration of Fourier features, high-resolution BEV, and text-based saliency detection may improve the accuracy of 3DOD decoder 220 by capturing fine-grained details, understanding semantic context, and identifying potential errors. The disclosed techniques may be more robust to variations in scene conditions and object appearances, as these techniques leverage multiple sources of information.

The ML system 216 may utilize the semantic information from the saliency maps to guide the 3DOD network. The proposal assessment unit 222 may adjust the confidence threshold dynamically based on the saliency map 312 information. Dynamic confidence thresholding may allow the 3DOD decoder 220 to be more flexible in decision-making process. By incorporating semantic information from saliency maps 312, the 3DOD decoder 220 may make more accurate predictions. Dynamic thresholding may help to reduce the number of false positive detections.

The trained CLIP model 310 may be used to understand the relationship between text queries and visual features. By providing text queries related to the scene (e.g., “car,” “pedestrian,” “traffic sign”), the ML system 216 may guide the CLIP model 310 to focus on specific objects or regions.

The CLIP model 310 may generate saliency maps 312 based on the text queries and the BEV feature maps. The saliency maps 312 may highlight regions of the image 314 that are relevant to the given text queries.

In one non-limiting example, the ML system 216 may employ the FeatUp techniques to upsample the saliency maps 312, ensuring the saliency maps 312 have high spatial resolution. Enhanced resolution may be beneficial for accurately identifying regions of interest (ROIs). A threshold may be applied to the saliency values to identify regions that are significantly salient. These regions may be considered potential ROIs. Based on the threshold, the saliency maps 312 may be used to extract bounding boxes or masks that define the ROIs. In an aspect, the CLIP model 310 may provide semantic guidance, ensuring that the saliency maps 312 focus on relevant objects based on the text queries. As noted above, FeatUp may help to improve the spatial resolution of the saliency maps 312, allowing for more accurate identification of ROIs.

ROIs may be areas within the BEV feature maps that are deemed more important based on the saliency maps 312. ROIs may be identified by setting a threshold on the saliency values.

In the disclosed implementation, the threshold may determine which regions are considered ROIs. Higher threshold values may result in fewer ROIs, while lower threshold values may identify more regions. For each prediction from the 3DOD decoder 220, the proposal assessment unit 222 may check if a bounding box or center point of the corresponding prediction falls within one of the identified ROIs. If a prediction is within an ROI, the proposal assessment unit 222 may increase the confidence score of that prediction based on the saliency value at that location. The amount of increase may be adjusted based on the saliency value, with higher saliency values leading to larger increases in confidence. Saliency maps 312 may provide valuable information about the importance of different regions in the scene. By focusing on ROIs identified through saliency maps 312, the proposal assessment unit 222 may prioritize predictions that are more likely to be correct. Increasing the confidence score of predictions within ROIs may help to counteract the effects of the initial confidence threshold of the 3DOD decoder 220, which might have suppressed some true positive detections. By re-evaluating confidence scores based on saliency information, the proposal assessment unit 222 may improve the accuracy of 3D object detection. The disclosed techniques may help to reduce the number of false positive detections by focusing on regions that are more likely to contain objects.

Dynamic thresholding is a technique where the confidence threshold used to filter predictions may be adjusted based on the characteristics of the current scene or data distribution. Dynamic thresholding may help to improve the performance of the ML system 216 by adapting to different conditions. In an aspect, the proposal assessment unit 222 may gather all the confidence scores generated by the 3DOD decoder 220 for the current scene.

In an aspect, the proposal assessment unit 222 may compute statistical properties of the confidence score distribution, such as, but not limited to: mean and standard deviation.

Mean is the average confidence score. Standard deviation is a measure of the spread of the confidence scores. Additional statistics such as, but not limited to, median, mode, or percentiles may also be considered by the proposal assessment unit 222. The statistical properties may provide insights into the distribution of confidence scores, helping to identify potential outliers or trends. These statistics may be used to dynamically adjust the threshold based on the characteristics of the distribution. One example threshold adjustment strategy may involve setting the confidence threshold a certain percentage above or below the mean confidence score. Another example strategy may involve setting the confidence threshold a certain number of standard deviations away from the mean. In an aspect, yet another example threshold adjustment strategy may involve setting the confidence threshold at a specific percentile of the confidence score distribution (e.g., 90th percentile).

In an aspect, the confidence threshold may be adjusted to match the characteristics of different scenes, improving performance in varying conditions.

The proposed techniques may involve dynamically adjusting the confidence threshold based on both the saliency maps 312 and the distribution of confidence scores within the scene. This dynamic threshold adjustment may allow the proposal assessment unit 222 to be more flexible and adaptive in its decision-making process. The proposal assessment unit 222 may set an initial base threshold, such as the mean confidence score. The proposal assessment unit 222 may calculate the saliency-weighted confidence scores for each proposal 306. Such calculations may involve multiplying the confidence score of a proposal by the saliency value at the corresponding location of the proposal 306. The proposal assessment unit 222 may analyze the distribution of these saliency-weighted confidence scores, calculating statistics like mean, standard deviation, and percentiles.

The proposal assessment unit 222 may adjust the base threshold dynamically based on the distribution properties and the saliency-weighted confidence scores. For example, the proposal assessment unit 222 may increase the threshold if the distribution of saliency-weighted scores is skewed towards higher values, indicating that proposals within high-saliency regions are generally more confident.

In summary, the ML system 216 may utilize Fourier features to capture fine-grained details and spatial variations in the BEV feature maps. The ML system 216 may create a high-resolution BEV feature map through concatenation and processing with an MLP. The ML system 216 may employ the CLIP model 310 with text queries to generate saliency maps 312, highlighting semantically relevant regions based on the queries, for example.

The ML system 216 may upsample the saliency maps 312 using FeatUp to ensure the saliency maps 312 have high spatial resolution for accurate ROI identification. The ML system 216 may define ROIs by setting a threshold on the saliency values, focusing on areas likely to contain objects. The ML system 216 may re-evaluate the confidence scores of predictions within ROIs by increasing them based on the corresponding saliency value. The disclosed techniques contemplate calculations of the distribution of confidence scores for all proposals. In one implementation, the ML system 216 may analyze the distribution properties (mean, standard deviation, percentiles). In an aspect, the ML system 216 may dynamically adjust the threshold based on the distribution and saliency-weighted confidence scores.

By incorporating semantic information from saliency maps and adapting thresholds, the ML system 216 may prioritize potentially correct detections. Dynamic thresholding and ROI-based evaluation may help to filter out less confident detections. Advantageously, the disclosed techniques may dynamically adjust to different scene conditions and object appearances.

In an aspect, the ML system 216 may implement other saliency-driven techniques describe below. In an example implementation, the ML system 216 may re-rank the 3DOD proposals based on their alignment with high-saliency regions in the scene. Furthermore, by assigning higher ranks to proposals that overlap with salient regions, the ML system 216 may prioritize detections that are more likely to be correct.

In an aspect, the ML system 216 may perform the initial 3DOD detection process using 3DOD decoder 220. The ML system 216 may overlay the saliency map 312 on top of the detected proposals 306. For proposals 306, the disclosed ML system 216 may calculate a saliency score of the proposal by averaging the saliency values within a bounding box of the proposal 306. Next, the ML system 216 may sort the proposals 306 based on their saliency scores in descending order, for example. The ML system 216 may boost the confidence scores of proposals with higher ranks. This may be achieved by using a linear or non-linear function to determine the amount of boost. Saliency maps 312 may provide valuable prior information about the importance of different regions in the scene.

In an aspect, by prioritizing proposals that align with salient regions, the ML system 216 may improve the accuracy of object detection. The technique of boosting the confidence scores of top-ranked proposals may help to ensure that the proposal 306 are considered as true positives, even if initial confidence scores of these proposals were low. Re-ranking proposals based on saliency may help to improve the overall accuracy of 3D object detection. By prioritizing proposals in salient regions, the ML system 216 may reduce the number of false positive detections.

Saliency maps 312 may be heatmaps that visually highlight regions of an image that are most relevant or informative for a given task. In the context of 3DOD, saliency maps 312 may optionally identify parts of a 3D object that are most likely to contribute to correct classification of the 3D object. Voting ensemble is a machine learning technique where multiple machine learning models (often trained on different subsets of data or using different algorithms) are combined to make predictions. The final prediction is typically determined by a voting mechanism, such as majority voting or weighted voting.

In yet another potential implementation, saliency-weighted voting ensemble may be a variant of the voting ensemble where the predictions of each model may be weighted based on the saliency scores of the corresponding regions. This technique may leverage the insight that predictions made in salient regions are likely to be more accurate than those made in less salient regions. In an aspect, the ML system 216 may train multiple 3DOD decoders 220 using different architectures (e.g., Faster R-CNN, YOLO) or using different training strategies (e.g., different hyperparameters, data augmentation techniques, and the like). This diversity may help improve the overall performance of the ensemble.

In an aspect, for each image in input image data 215, the ML system 216 may generate saliency maps 312 using techniques like gradient-based methods (e.g., Grad-CAM, SmoothGrad) or class activation maps (CAM). These saliency maps may highlight the regions of the object that are more important for the predictions of the 3DOD decoders 220. For each prediction made by a corresponding 3DOD decoder 220, the ML system 216 may assign a weight based on the saliency score of the corresponding region.

Regions with higher saliency scores may receive higher weights. This may be achieved using a simple linear scaling or a more complex function that accounts for the distribution of saliency scores. In an aspect, for each region of the input image, such as image 314, the ML system 216 may combine the weighted predictions from all 3DOD decoders 220. The weighted predictions may be combined using a simple averaging scheme or a more sophisticated method like weighted sum or weighted voting. The final output may be adjusted based on the confidence level of the predictions. In one implementation, regions with higher combined weights and more consistent predictions across 3DOD decoders 220 may be assigned higher confidence scores. By focusing on salient regions, the ensemble may make more accurate predictions, especially for complex or challenging objects. The ensemble may be less susceptible to the overfitting or underfitting of individual models, as the combined predictions may help mitigate the effects of errors.

Generally, in deep learning, attention mechanisms may be used to selectively focus on specific parts of an input, allowing the model to concentrate on the most relevant information. In the context of 3DOD, attention may help the 3DOD decoder 220 focus on regions of the image 314 that are most likely to contain objects. In yet another potential implementation, by incorporating saliency maps 312 into the attention mechanism, the ML system 216 may guide the focus of 3DOD decoder 220 towards regions that are deemed more important based on the saliency scores.

As in the previously disclosed techniques, the ML system 216 may generate saliency maps 312 for each input image in the image data 215. The attention mechanism in the 3DOD decoder 220 typically involves computing attention scores for different regions of the input.

In an aspect, to incorporate saliency maps 312, the ML system 216 may modify the attention mechanism process as described below. For instance, the ML system 216 may concatenate the saliency map 312 with the input features the (e.g., BEV grid features 318) to create a combined feature representation.

In other words, the 3DOD decoder 220 may use the combined features to compute attention scores. The saliency map 312 may influence the attention scores, making the 3DOD decoder 220 more likely to focus on regions with higher saliency values. The 3DOD decoder 220 may use the attention scores to weight the features, giving more importance to regions with higher attention scores. In addition, the attention-weighted features may then be used to compute the final object detection predictions. By focusing on regions highlighted by the saliency map 312, the 3DOD decoder 220 may potentially enhance the feature representation of objects in those regions, leading to higher confidence scores. As an example of benefits of saliency-guided attention, by focusing on salient regions, the 3DOD decoder 220 may learn more discriminative features for objects in those regions. Objects detected in salient regions may be likely to have higher confidence scores, as the 3DOD decoder 220 may be paying more attention to these regions. The attention mechanism may help the 3DOD decoder 220 avoid detecting false positives in less important regions.

In essence, saliency gradients are the derivatives of the saliency map 312, indicating the rate of change in saliency across different regions. Regions with high gradients may suggest rapid changes in saliency, while regions with low gradients may suggest gradual changes.

In yet another potential implementation, by applying a smoothing technique to confidence scores in regions with high saliency gradients, the ML system 216 may reduce abrupt changes in confidence levels.

In an aspect, confidence smoothing may lead to more consistent and reliable predictions, especially in areas where the saliency map 312 may have noisy or ambiguous information. The ML system 216 may calculate the gradients of the saliency map 312 using various methods, such as, but not limited to, finite differences or gradient operators. These saliency gradients may highlight regions where the saliency changes rapidly. For predictions in regions with high saliency gradients, the ML system 216 may apply a smoothing function to their confidence scores.

For example, the ML system 216 may convolve the confidence scores with a Gaussian kernel to introduce a degree of smoothing.

As another example, the ML system 216 may calculate a moving average of the confidence scores within a specified window.

As yet another alternative technique, the ML system 216 may replace the confidence score with the median value of neighboring scores.

To further enhance the confidence of predictions in high-saliency regions, the ML system 216 may boost the confidence scores of high-saliency regions by a certain factor. The boosting may be done based on the magnitude of the saliency gradients or other relevant metrics. In this case, smoothing may help mitigate the impact of noisy or inconsistent saliency maps 312, leading to more stable confidence scores. In an aspect, predictions in regions with gradually changing saliency are more likely to have consistent confidence levels.

FIGS. 4A and 4B are block diagrams illustrating implementation of a FeatUp framework applied to both camera backbone features and polar BEV features, in accordance with the techniques of this disclosure.

Many backbone architectures used in 3D object detection significantly downscale feature maps. In other words, information may be pooled over large areas, reducing spatial resolution. Downscaling may hinder the ability to perform dense prediction tasks like segmentation and object detection, which operate better using fine-grained spatial information. FeatUp is a versatile framework that may be applied to various deep learning models, regardless of their specific architecture. As noted above, FeatUp may be designed to restore the spatial information lost in deep features. FeatUp may achieve this by upsampling the feature maps while preserving semantic information. FeatUp may help to recover the spatial details that are lost due to downscaling as well as downsampling mentioned above. By restoring spatial information, the FeatUp technique may improve the performance of dense prediction tasks, such as object detection and segmentation.

In accordance with the techniques of the present disclosure, the FeatUp framework may be applied to both the camera backbone features and the polar BEV features. This double application may ensure that the resulting feature maps (including the BEV feature maps) have rich spatial resolution, capturing both high-level semantic information and fine-grained details. The high-resolution feature maps may be well-suited for dense prediction tasks like object detection and segmentation in BEV space. The combination of FeatUp and BEV space may enable accurate dense predictions by providing feature maps with the necessary detail and semantic understanding. The disclosed techniques lead to an overall improvement in the performance of the 3DOD decoder 220, allowing for more accurate and robust object detection in 3D environments.

FIG. 4A illustrates the FeatUp framework applied to the camera backbone features. In one non-limiting example, the FeatUp framework may be implemented by a deep learning architecture, specifically a generative adversarial network (GAN), designed for image super-resolution. The framework illustrated in FIG. 4 is configured to take a low-resolution image (image data 215) and generate a higher-resolution version of the image and/or higher resolution features of the image data 215.

The freeze feature extractor 402 (e.g., a convolutional neural network) may extract features from the image data 215. It should be noted that freeze feature extractor 402 is shown as feature extractor 217 in FIG. 2. In an aspect, the freeze feature extractor 402 may be configured to extract features from the backbone network of one or more cameras 130-134. In one example, the backbone network may comprise a pre-trained convolutional neural network. These features may provide additional information about the image data 215. In an aspect, the extracted features may be perturbed in different ways, such as, but not limited to, flipping horizontally or vertically, or scaling the features down to generate the perturbed features 404. This step may help the disclosed framework learn to generate diverse and realistic outputs. In an aspect, learned down sampler 410 may be a component configured to downsample the perturbed features 404, creating a lower-resolution representation. Latent high resolution map 412 illustrated in FIG. 4A may be a latent space representation of the desired high-resolution image. In an aspect, joint bilinear sampler 414 may be a component configured to combine the downsampled features 408 and the latent high-resolution map 412 to generate high-resolution features (e.g., FeatUp features 308 shown in FIG. 3). In an aspect, reconstruction loss 406 is a loss function that may be used to measure the difference between the generated high-resolution features and the downsampled features 408 (having lower resolution) that may be generated by the learned down sampler 410.

FIG. 4B illustrates a deep learning architecture designed for BEV feature upsampling. The illustrated architecture may can take low-resolution BEV features and generate higher-resolution versions, which may be used by the ML system 216 as discussed in greater detail above. Just like in FIG. 4A, the process may start with the freeze feature extractor 402 extracting features from image data 215. In this case, the extracted features may be upsampled using the FeatUp method to generate a plurality of upsampled features 416, which may increase spatial resolution of the extracted features. Next, the upsampled features may be projected onto a BEV grid, which is a top-down view of the scene. In an aspect, The PV to BEV projection unit 218 may project PV images onto the BEV grid 304. Similarly to FIG. 4A, the projected BEV features may be perturbed in different ways, such as flipping horizontally or vertically, or scaling them down to generate perturbed BEV features 418. The learned down sampler 410 may be configured to downsample the perturbed BEV features 418 to generate downsampled BEV features 420. In this case, latent high resolution map 412 may be a latent space representation of the desired high-resolution BEV features. In an aspect, joint bilinear sampler 414 may combine the downsampled BEV features 420 and the latent high-resolution map 412 to generate high-resolution BEV features. Overall, the deep learning architecture illustrated in FIG. 4B may generate high-resolution BEV features by understanding the features of the input data 215 and using a generative process to create a more detailed top-down view of the scene.

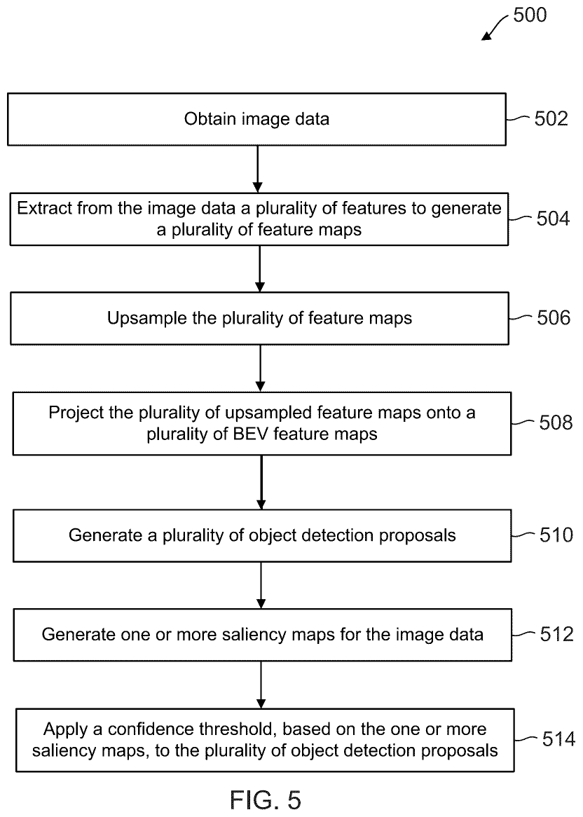

FIG. 5 is a flowchart illustrating an example method for saliency-driven refinement of predictions, in accordance with the techniques of this disclosure. Although described with respect to computing system 200 (FIG. 2), it should be understood that other devices may be configured to perform a method similar to that of FIG. 5.

In this example, ML system 216 may initially obtain image data 215 from one or more sensor of vehicle 102 (502). The image data 215 may include one or more images captured by one or more cameras 130-134. The ML system 216 may extract, from the image data 215, a plurality of features to generate a plurality of feature maps (504). In the example of FIG. 2, feature extractor 217 may be configured to extract features from image data 215, as described herein. Next, the ML system 216 may upsample the plurality of feature maps (506). In an aspect, FeatUp technique may be used to upsample low-resolution feature maps generated by the feature extractor 217. The ML system 216 may project the plurality of upsampled feature maps onto a plurality of BEV feature maps (508). The PV to BEV projection unit 218 may project PV images onto the BEV plane 302 using techniques like, but not limited to, inverse perspective mapping. Next, the ML system 216 may generate a plurality of object detection proposals (510). Proposals with confidence scores below a confidence threshold may be discarded. However, the confidence threshold mechanism may inadvertently suppress some true positive proposals. In accordance with the techniques of the present disclosure, the ML system 216 may generate one or more saliency maps for image data 215 (512). Finally, the ML system 216 may apply a confidence threshold, based on the one or more saliency maps, to the plurality of object detection proposals to generate refined object detection proposals (514). Advantageously, the proposal assessment unit 222 may be configured to adjust predictions of the 3DOD decoder 220 based on the information from the saliency maps, potentially restoring suppressed true positives or refining object boundaries.

The following numbered clauses illustrate one or more aspects of the devices and techniques described in this disclosure.

Clause 1. A method for saliency-driven refinement of object detection proposals includes obtaining image data generated by one or more sensors of a vehicle; extracting, from the image data, a plurality of features to generate a plurality of feature maps; upsampling the plurality of feature maps to generate a plurality of upsampled feature maps, wherein the upsampling increases a spatial resolution of the plurality of feature maps; projecting the plurality of upsampled feature maps onto a plurality of Bird's Eye View (BEV) feature maps; generating, based on the plurality of BEV feature maps, a plurality of object detection proposals for the image data; generating one or more saliency maps for the image data; and applying a confidence threshold, based on the one or more saliency maps, to the plurality of object detection proposals to generate refined object detection proposals.

Clause 2. The method of clause 1, further comprising: adjusting, based on the one or more saliency maps, the confidence threshold.

Clause 3. The method of clause 1, wherein the plurality of object detection proposals include one or more suppressed true positives.

Clause 4. The method of claim 1, further comprising: incorporating positional and color components of the image data into the plurality of BEV feature maps.

Clause 5. The method of clause 4, wherein the positional and color components include information about spatial frequency content of a corresponding BEV feature map.

Clause 6. The method of clause 4, wherein the positional and color components include Fourier features and wherein incorporating the positional and color components further comprises: incorporating the positional and color components of the image data into the plurality of BEV feature maps using a multi-layer perceptron (MLP), wherein the Fourier features comprise an input into the MLP.

Clause 7. The method of any of clauses 1-6, wherein generating the one or more saliency maps for the image data further comprises: generating the one or more saliency maps using a pre-trained Contrastive Language-Image Pre-training (CLIP) model.

Clause 8. The method of any of clauses 1-7, wherein projecting the plurality of upsampled feature maps onto the plurality of BEV feature maps further comprises: generating a BEV grid representing an environment surrounding the vehicle.

Clause 9. The method of any of clauses 1-8, further comprising operating an Advanced Driver Assistance System (ADAS) based on the refined object detection proposals.

Clause 10. A system for saliency-driven refinement of object detection proposals, the system comprising: a memory for storing image data; and processing circuitry in communication with the memory, wherein the processing circuitry is configured to: obtain the image data generated by one or more sensors of a vehicle; extract, from the image data, a plurality of features to generate a plurality of feature maps; upsample the plurality of feature maps to generate a plurality of upsampled feature maps, wherein the upsampling increases a spatial resolution of the plurality of feature maps; project the plurality of upsampled feature maps onto a plurality of Bird's Eye View (BEV) feature maps; generate, based on the plurality of BEV feature maps, a plurality of object detection proposals for the image data; generate one or more saliency maps for the image data; and apply a confidence threshold, based on the one or more saliency maps, to the plurality of object detection proposals to generate refined object detection proposals.

Clause 11. The system of clause 10, wherein the processing circuitry is further configured to: adjust, based on the one or more saliency maps, the confidence threshold.

Clause 12. The system of clause 10, wherein the plurality of object detection proposals include one or more suppressed true positives.

Clause 13. The system of clause 10, wherein the processing circuitry is further configured to: incorporate positional and color components of the image data into the plurality of BEV feature maps.

Clause 14. The system of clause 13, wherein the positional and color components include information about spatial frequency content of a corresponding BEV feature map.

Clause 15. The system of clause 13, wherein the positional and color components include Fourier features and wherein the processing circuitry configured to incorporate the positional and color components is further configured to: incorporate the positional and color components of the image data into the plurality of BEV feature maps using a multi-layer perceptron (MLP), wherein the Fourier features comprise an input into the MLP.

Clause 16. The system of any of clauses 10-15, wherein the processing circuitry configured to generate the one or more saliency maps for the image data is further configured to: generate the one or more saliency maps using a pre-trained Contrastive Language-Image Pre-training (CLIP) model.

Clause 17. The system of any of clauses 10-16, wherein the processing circuitry configured to project the plurality of upsampled feature maps onto the plurality of BEV feature maps is further configured to: generate a BEV grid representing an environment surrounding the vehicle.

Clause 18. The system of any of clauses 10-17, wherein the processing circuitry is further configured to: operate an Advanced Driver Assistance System (ADAS) based on the refined object detection proposals.

Clause 19. Non-transitory computer-readable storage media having instructions encoded thereon, the instructions configured to cause processing circuitry to: obtain image data generated by one or more sensors of a vehicle; extract, from the image data, a plurality of features to generate a plurality of feature maps; upsample the plurality of feature maps to generate a plurality of upsampled feature maps, wherein the upsampling increases a spatial resolution of the plurality of feature maps; project the plurality of upsampled feature maps onto a plurality of Bird's Eye View (BEV) feature maps; generate, based on the plurality of BEV feature maps, a plurality of object detection proposals for the image data; generate one or more saliency maps for the image data; and apply a confidence threshold, based on the one or more saliency maps, to the plurality of object detection proposals to generate refined object detection proposals.

Clause 20. The non-transitory computer-readable storage media of clause 19, wherein the instructions are further configured to cause the processing circuitry to: adjust, based on the one or more saliency maps, the confidence threshold.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for saliency-driven refinement of object detection proposals comprising:
obtaining image data generated by one or more sensors of a vehicle;
extracting, from the image data, a plurality of features to generate a plurality of feature maps;
upsampling the plurality of feature maps to generate a plurality of upsampled feature maps, wherein the upsampling increases a spatial resolution of the plurality of feature maps;
projecting the plurality of upsampled feature maps onto a plurality of Bird's Eye View (BEV) feature maps;
generating, based on the plurality of BEV feature maps, a plurality of object detection proposals for the image data;
generating one or more saliency maps for the image data; and
applying a confidence threshold, based on the one or more saliency maps, to the plurality of object detection proposals to generate refined object detection proposals.

2. The method of claim 1, further comprising:
adjusting, based on the one or more saliency maps, the confidence threshold.

3. The method of claim 1, wherein the plurality of object detection proposals include one or more suppressed true positives.

4. The method of claim 1, further comprising:
incorporating positional and color components of the image data into the plurality of BEV feature maps.

5. The method of claim 4, wherein the positional and color components include information about spatial frequency content of a corresponding BEV feature map.

6. The method of claim 4, wherein the positional and color components include Fourier features and wherein incorporating the positional and color components further comprises:
incorporating the positional and color components of the image data into the plurality of BEV feature maps using a multi-layer perceptron (MLP),
wherein the Fourier features comprise an input into the MLP.

7. The method of claim 1, wherein generating the one or more saliency maps for the image data further comprises:
generating the one or more saliency maps using a pre-trained Contrastive Language-Image Pre-training (CLIP) model.

8. The method of claim 1, wherein projecting the plurality of upsampled feature maps onto the plurality of BEV feature maps further comprises:
generating a BEV grid representing an environment surrounding the vehicle.

9. The method of claim 1, further comprising operating an Advanced Driver Assistance System (ADAS) based on the refined object detection proposals.

10. A system for saliency-driven refinement of object detection proposals, the system comprising:
a memory for storing image data; and
processing circuitry in communication with the memory, wherein the processing circuitry is configured to:
obtain the image data generated by one or more sensors of a vehicle;
extract, from the image data, a plurality of features to generate a plurality of feature maps;
upsample the plurality of feature maps to generate a plurality of upsampled feature maps, wherein the upsampling increases a spatial resolution of the plurality of feature maps;
project the plurality of upsampled feature maps onto a plurality of Bird's Eye View (BEV) feature maps;
generate, based on the plurality of BEV feature maps, a plurality of object detection proposals for the image data;
generate one or more saliency maps for the image data; and
apply a confidence threshold, based on the one or more saliency maps, to the plurality of object detection proposals to generate refined object detection proposals.

11. The system of claim 10, wherein the processing circuitry is further configured to:
adjust, based on the one or more saliency maps, the confidence threshold.

12. The system of claim 10, wherein the plurality of object detection proposals include one or more suppressed true positives.

13. The system of claim 10, wherein the processing circuitry is further configured to:
incorporate positional and color components of the image data into the plurality of BEV feature maps.

14. The system of claim 13, wherein the positional and color components include information about spatial frequency content of a corresponding BEV feature map.

15. The system of claim 13, wherein the positional and color components include Fourier features and wherein the processing circuitry configured to incorporate the positional and color components is further configured to:
incorporate the positional and color components of the image data into the plurality of BEV feature maps using a multi-layer perceptron (MLP),
wherein the Fourier features comprise an input into the MLP.

16. The system of claim 10, wherein the processing circuitry configured to generate the one or more saliency maps for the image data is further configured to:
generate the one or more saliency maps using a pre-trained Contrastive Language-Image Pre-training (CLIP) model.

17. The system of claim 10, wherein the processing circuitry configured to project the plurality of upsampled feature maps onto the plurality of BEV feature maps is further configured to:
generate a BEV grid representing an environment surrounding the vehicle.

18. The system of claim 10, wherein the processing circuitry is further configured to:
operate an Advanced Driver Assistance System (ADAS) based on the refined object detection proposals.

19. Non-transitory computer-readable storage media having instructions encoded thereon, the instructions configured to cause processing circuitry to:
obtain image data generated by one or more sensors of a vehicle;
extract, from the image data, a plurality of features to generate a plurality of feature maps;
upsample the plurality of feature maps to generate a plurality of upsampled feature maps, wherein the upsampling increases a spatial resolution of the plurality of feature maps;
project the plurality of upsampled feature maps onto a plurality of Bird's Eye View (BEV) feature maps;
generate, based on the plurality of BEV feature maps, a plurality of object detection proposals for the image data;
generate one or more saliency maps for the image data; and
apply a confidence threshold, based on the one or more saliency maps, to the plurality of object detection proposals to generate refined object detection proposals.

20. The non-transitory computer-readable storage media of claim 19, wherein the instructions are further configured to cause the processing circuitry to:
adjust, based on the one or more saliency maps, the confidence threshold.
